(19) United States
(12) Patent Application Publication
(10) Pub. No.: US 2020/0267964 A1
(43) Pub. Date: Aug. 27, 2020

(54) EQUIPMENT FOR ELIMINATING GRASS SEEDS IN FARMLAND

(71) Applicant: TIEN-CHANG CHEN, PINGTUNG COUNTY (TW)

(72) Inventor: TIEN-CHANG CHEN, PINGTUNG COUNTY (TW)

(21) Appl. No.: 16/284,013

(22) Filed: Feb. 25, 2019

(51) Int. Cl. A01M 21/04; G02B 3/08; A01B 39/18; A01B 71/02; A01B 79/00

(52) U.S. Cl. CPC A01M 21/04; G02B 3/08; A01B 76/00; A01B 71/02; A01B 79/005; A01B 39/18

(57) ABSTRACT

The present invention relates to an equipment for eliminating grass seeds in farmland, comprising a self-propelled device, a power system connected to the self-propelled device for driving the self-propelled device to walk along a fixed path in a farmland, a rack connected to the self-propelled device, and plural focusing lenses disposed in the rack.

### BACKGROUND OF THE INVENTION

### 1. Field of the Invention

The present invention relates to an equipment for eliminating grass seeds in farmland using high temperature heat generated from natural sunlight so as to avoid weeds consuming nutrients originally intended to supply to the crop.

### 2. Description of Related Art

During cultivation of gardening plants and crops including flowers, fruit trees, vegetables and plants for specific use in home garden or farmland, weeds problem which reduces growth of the gardening plants and crops usually occurred. The weeds have strong viability and absorb available nutrient in the soil excessively, so the gardening plants and crops cannot grow well in the presence of weeds.

In farmland using organic fertilizer, the weeds are usually growth vigorously. Herbicides are usually used for weed control and eliminate weeds rapidly, but the herbicides are also harmful to environment and people. In addition, for cultivating herbicide-sensitive crops, a lot of manpower is needed to eliminate unwanted weeds manually which is not efficient. In a large farmland, people take few days to complete weeding from a first side to a second side of the large farmland, but weeds of the first side re-grow after few days, so weeding by manpower is a not efficient and useless. Furthermore, sharp tools such as sickles used for weeding manually may cut the crops near the weeds accidentally and affect the growth of the crop or lead to death of the crop.

Additionally, the weeds removed manually are usually incinerated and burned in the farmland. Weed incineration causes air pollution, and the soil nutrients loss caused by the burned farmland which cannot apply for plant cultivation immediately. Therefore, how to get rid of weed is one of the topics needed to be solved urgently by the farmer.

### SUMMARY OF THE INVENTION

The present invention provides an equipment for eliminating grass seeds in farmland which eliminates the grass seeds using high temperature heat generated from natural sunlight so as to avoid weeds consuming nutrients originally intended to supply to the crop.

The equipment for eliminating grass seeds in a farmland of the present invention comprises a self-propelled device, a power system, a rack and plural focusing lenses. The self-propelled device is connected to the power system and driven by the power system to walk along a fixed path in the farmland. The self-propelled device is connected to the rack, and the plural focusing lenses are disposed in the rack. Each of the plural focusing lenses has an entrance surface for receiving plural incident rays of sunlight and an exit surface facing the farmland. The plural incident rays of sunlight from the entrancing surface are focused and emitted from the exit surface to the farmland for burning and damaging plural grass seeds in the farmland.

According to an embodiment of the present invention, each of the plural focusing lenses is a Fresnel lens.

According to an embodiment of the present invention, the self-propelled device has a case and a wheel assembly disposed at a bottom of the case and connected to the power system to drive the self-propelled device to move.

According to an embodiment of the present invention, the power system comprises a reduction motor for driving the self-propelled device walk smoothly along the fixed path in the farmland.

According to an embodiment of the present invention, the self-propelled device is controlled by strings, a remote control, a GPS positioning or a laser positioning to walk along the fixed path in the farmland.

According to an embodiment of the present invention, the self-propelled device is provided with plural positioning poles for connecting and fixing the rack to the self-propelled device.

According to an embodiment of the present invention, the rack is provided with plural trays pivoted to the rack, and each of the plural trays is provided with plural slots therein for mounting the plural focusing lenses. The plural focusing lenses are arranged in a staggered manner in two adjacent trays and arranged into a parallelogram in the rack. Accordingly, a soil of the farmland is exposed to the plural incident rays of sunlight focused by the plural focusing lenses in an average distance and a best efficacy of burning grass seeds by the focused sunlight is achieved.

According to an embodiment of the present invention, each of the plural slots is provided with two positioning members attached to two laterals thereof for positioning the plural focusing lenses in each of the plural slots.

According to an embodiment of the present invention, a sun tracking system is further provided and has an angle regulation pole passing through the plural trays for regulating a rotation angle of the plural trays relative to the rack for receiving the plural incident rays of sunlight efficiently to achieve the best efficacy for burning grass seeds.

According to an embodiment of the present invention, the angle regulation pole is controlled manually or automatically by a controller to regulate the rotation angle according to the sunlight duration.

According to an embodiment of the present invention, the self-propelled device is provided with a scraper at a back side thereof for scratching soils of the farmland to expose the grass seeds buried in the soils.

According to an embodiment of the present invention, a temperature sensor is provided and connected to the self-propelled device and the power system. The temperature sensor has at least one probe disposed at a light path of the plural focusing lenses to detect a temperature of the plural incident rays of sunlight, and the temperature sensor turns on the power system for driving the self-propelled device to walk on the farmland when the temperature of the plural incident rays of sunlight detected by the at least one probe reaches a preset temperature.

According to an embodiment of the present invention, the preset temperature is about 90° C.

According to an embodiment of the present invention, a warning notifier is further provided and connected to the self-propelled device and the power system. The warning notifier automatically generates a warning message to notify a user to change a patrol path of the self-propelled device after the self-propelled device completes a walking task on the farmland.

According to an embodiment of the present invention, the warning notifier is a laser sensor, a buzzer or a lamp.

### BRIEF DESCRIPTION OF THE DRAWINGS

FIG. 1 is a top view showing an equipment for eliminating grass seeds in farmland of the present invention;

FIG. 2 is a schematic diagram showing the present invention in use;

FIG. 3 is a partially enlarged schematic diagram showing a mode of action of the present invention;

FIG. 4 is a side view showing an angle regulation pole assembled to the present invention;

FIG. 5 is a schematic diagram showing an angle regulation pole of the present invention in use.

### DETAILED DESCRIPTION OF THE PREFERRED EMBODIMENT

To provide a thorough understanding, the purpose and advantages of the present invention will be described in detail with reference to the accompany drawings.

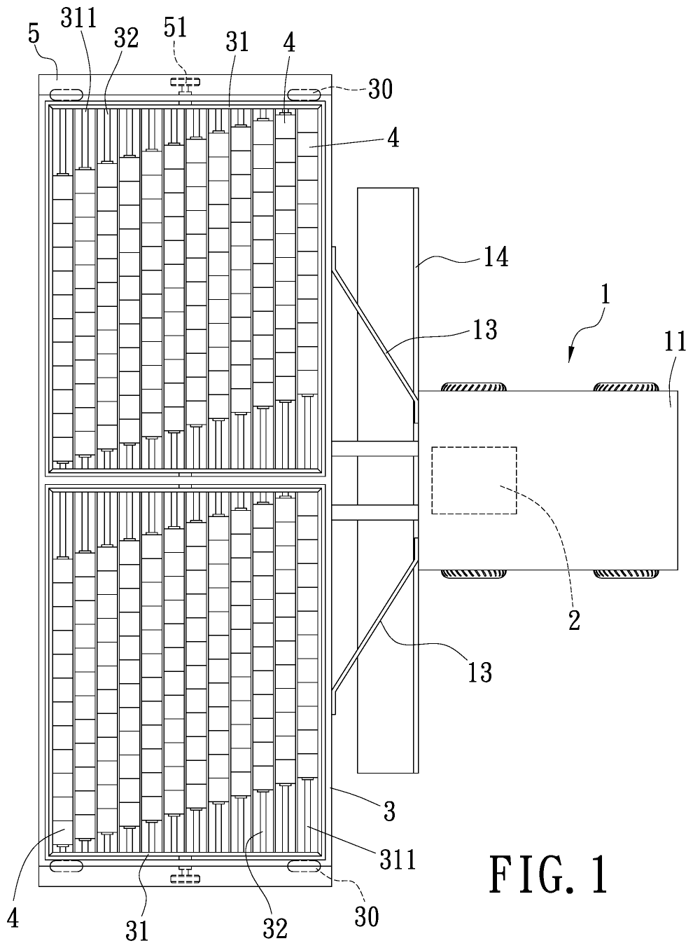

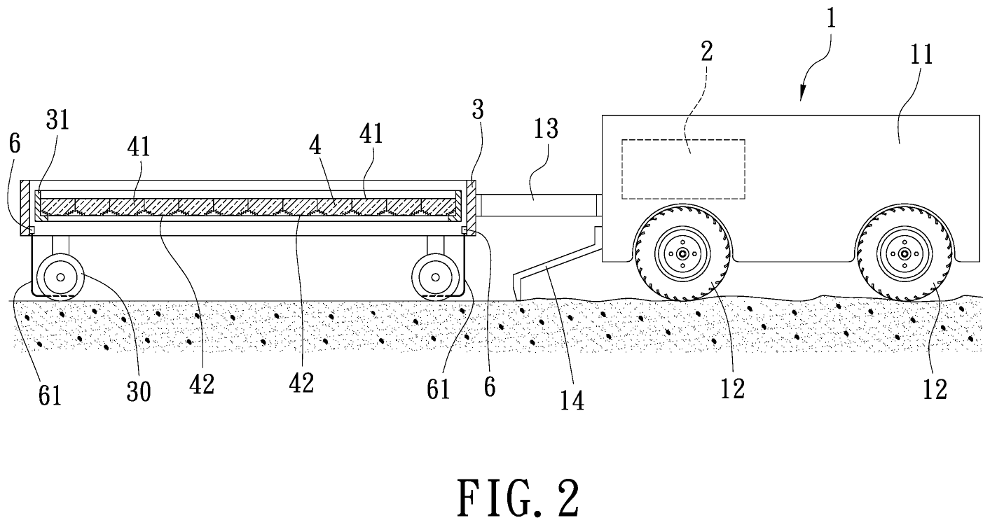

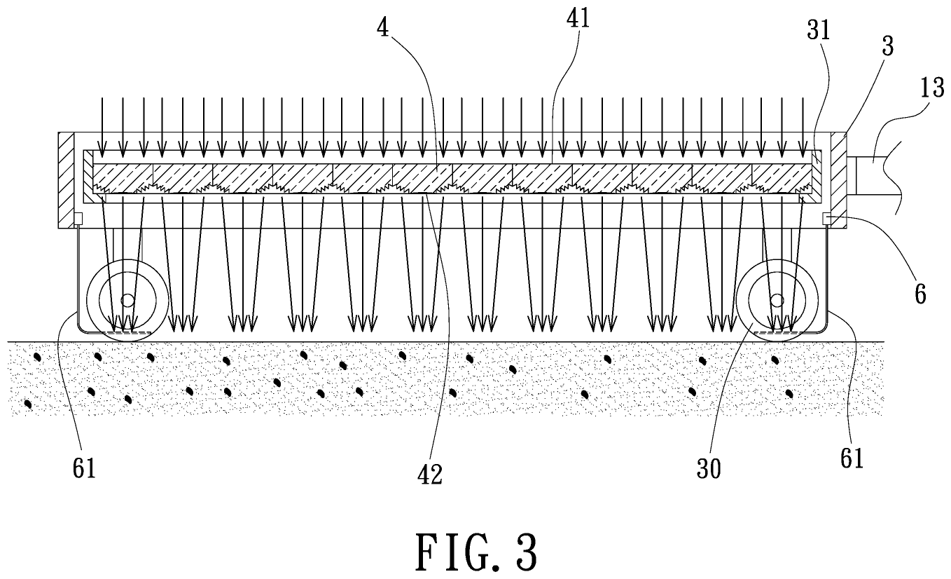

Referring to FIG. 1 to FIG. 3, the equipment for eliminating grass seeds in a farmland of the present invention comprises a self-propelled device (1), a power system (2), a rack (3) and plural focusing lenses (4). The power system (2) is connected to the self-propelled device (1) for driving the self-propelled device (1) to walk along a fixed path in the farmland. The rack (3) is connected to the self-propelled device (1) and has plural wheels (30). The plural focusing lenses (4) is disposed in the rack (3) and each of the plural focusing lenses (4) has an entrance surface (41) for receiving plural incident rays of sunlight and an exit surface (42) facing the farmland for emitting the plural incident rays of sunlight focused on the farmland for burning and damaging plural grass seeds in the farmland.

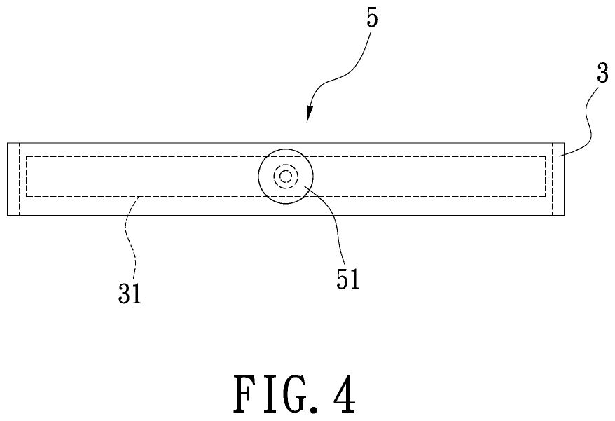

Referring to FIG. 1 to FIG. 4, different embodiments for using the present invention in the farmland are disclosed and described as below.

The self-propelled device (1) comprises a case (11) and a wheel assembly (12) disposed at a bottom of the case (11). The wheel assembly (12) is connected to a power system (2) to drive the self-propelled device (1) to move. In one embodiment, the power system (2) is a motor to drive the wheel assembly (12) rotate so as to drive the self-propelled device (1) to move. The power system (2) is further provided with a reduction motor for driving the self-propelled device (1) walking smoothly along a fixed path in the farmland since a rotating speed of the traditional motor is too fast. Furthermore, the self-propelled device (1) is provided with plural positioning poles (13) for connecting and fixing the rack (3) to the self-propelled device (1). The usage number and placing positions of the plural positioning poles (13) on the rack (3) are depend on the size and the shape of the rack (3).

In one embodiment of the present invention, each of the plural focusing lenses (4) disposed in the rack (3) is a convex lens or a Fresnel lens, and the plural focusing lenses (4) are installed in the rack (3) by the following manner. The rack (3) comprises plural trays (31) pivoted to the rack (3), and each of the plural trays (31) has plural slots (311) therein for mounting the plural focusing lenses (4). The plural focusing lenses (4) are arranged in a staggered manner in two adjacent slots (311) and arranged into a parallelogram in the rack (3). In addition, each of the plural slots (311) is provided with two positioning members (32) attached to two laterals of the slot (311) for positioning the plural focusing lenses (4) in each of the plural slots (311). After the equipment for eliminating grass seeds in farmland of the invention is assembled, the self-propelled device (1) is driven by the power system (2) to walk along a fixed path in the farmland. Several methods are used to control the walking path of the self-propelled device (1), comprises:

1. String: a pile is fixed at one end of a path, and the self-propelled device (1) is connected to the pile by a string to pull the self-propelled device (1) walking along the path in the farmland.

2. Remote control: the self-propelled device (1) is provided with a signal receiver for receiving a control signal sent by a remote control, and a user is allowed to control the self-propelled device (1) such as a prototype walking along a fixed path in the farmland.

3. Global positioning system (GPS) positioning: the self-propelled device (1) is provided with a GPS positioning system and is guided by a satellite positioning system to walk along a fixed path set up by the user in the farmland by the GPS positioning system.

4. Laser positioning: the self-propelled device (1) is provided with a laser receiver for receiving a beam sent by a laser transmitter, and the self-propelled device (1) is guided by the beam to walk along a fixed path in the farmland.

By the above methods, the self-propelled device (1) provided with the rack (3) is driven by the power system (2) to walk alone a fixed path in the fanned. When the present invention is walking in the farmland, each of the plural focusing lenses (4) in the rack (3) receives plural incident rays of sunlight by an entrance surface (41), and the plural incident rays of sunlight is then emitted from an exit surface (42) of the focusing lens (4) facing the farmland and is focus on the farmland to burn and damage plural grass seeds in soils in the farmland.

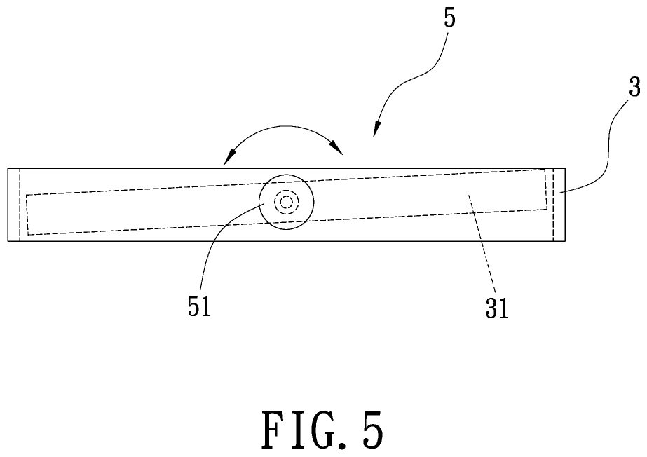

Referring to FIG. 1 to FIG. 5, irradiation angles of the plural incident rays of sunlight are changing all day, so a sunlight receiving efficacy of the plural focusing lenses (4) is affected by the irradiation angles. So, a sun tracking system (5) having an angle regulation pole (51) passing through the plural trays (31) is further provided to the track (3) connected to the self-propelled device (1). The angle regulation pole (51) regulates a rotation angle of the tray (31) relative to the rack (3) in response to the angle of the plural incident rays of sunlight so as to achieve a best efficacy for receiving sunlight and a complete efficacy for burning and damaging grass seeds in the farmland. In addition, the angle regulation pole (51) is controlled manually or automatically by a controller to regulate the rotation angle according to the sunlight duration.

The grass seeds are usually buried in soil mounds which are uneven after soil preparation and are not burned and damaged completely when the self-propelled device (1) is walking alone a fixed path in the farmland. To eliminate the grass seeds completely, the self-propelled device (1) is further provided with a scraper (14) at a back side of the self-propelled device (1) for scratching soils of the farmland to expose the grass seeds buried in the soil mounds to the plural incident rays of sunlight emitted from the exit surface (42) of each of the plural focusing lenses (4). Therefore, the grass seeds buried in the soil mounds are burned and damaged completely by the present invention.

The present invention further comprises a temperature sensor (6) having at least one probe (61) disposed at a light path of the plural focusing lenses (4) to detect a temperature of the plural incident rays of sunlight. The temperature sensor (6) is connected to the self-propelled device (1) and the power system (2), when the temperature of the plural incident rays of sunlight reaches to a preset temperature, for example, the preset temperature is about 90° C., the power system (2) is turned on to drive the self-propelled device (1) to walk in the farmland to burn and eliminate grass seeds.

Furthermore, the present invention is provided with a warning notifier which is connected to the self-propelled device (1) and the power system (2). The warning notifier automatically generates a warning message to notify a user to change a patrol path of the self-propelled device (1) after the self-propelled device (1) completes a walking task on the farmland. The warning notifier is a laser sensor, a buzzer or a lamp.

Accordingly, the present invention has advantages described below compared to the traditional technologies:

1. The present invention utilizes sunlight to eliminate grass seeds in soil which is natural and harmless to the environment so as to save manpower and achieve efficacies of pollution-free and environmental protection.

2. The present invention utilizes focusing lenses to focus plural incident rays of sunlight on the farmland and form plural focal points on the farmland to burn and damage grass seeds in the soil for preventing growth of weeds.

3. The present invention comprises an angle regulation pole to regulate a rotation angle of the tray relative to the rack for receiving sunlight in response to the angle of the plural incident rays of sunlight, so a best efficacy for receiving sunlight and a complete efficacy for burning and damaging grass seeds are achieved.

4. The present invention prevents growth of weeds and avoids weeds consuming nutrients originally intended to supply to the crop without interference growing status of the corps.

What is claimed is:

1. An equipment for eliminating grass seeds in a farmland, comprising:
a self-propelled device;
a power system connected to the self-propelled device for driving the self-propelled device to walk along a fixed path in the farmland;
a rack having plural wheels connected to the self-propelled device; and
plural focusing lenses disposed in the rack and each of which has an entrance surface for receiving plural incident rays of sunlight and an exit surface facing the farmland for emitting the plural incident rays of sunlight focused on the farmland for burning and damaging plural grass seeds in the farmland.

2. The equipment for eliminating grass seeds in a farmland as claimed in claim 1, wherein plural trays are pivoted in the rack and each of which having plural slots therein for mounting the plural focusing lenses, and wherein the plural focusing lenses are arranged in a staggered manner in two adjacent slots and arranged into a parallelogram in the rack.

3. The equipment for eliminating grass seeds in farmland as claimed in claim 2, wherein each of the plural slots is provided with two positioning members attached to two laterals thereof for positioning the plural focusing lenses in each of the plural slots.

4. The equipment for eliminating grass seeds in farmland as claimed in claim 1, wherein each of the plural focusing lenses is a Fresnel lens.

5. The equipment for eliminating grass seeds in farmland as claimed in claim 2, wherein each of the plural focusing lenses is a Fresnel lens.

6. The equipment for eliminating grass seeds in farmland as claimed in claim 3, wherein each of the plural focusing lenses is a Fresnel lens.

7. The equipment for eliminating grass seeds in farmland as claimed in claim 1, wherein the self-propelled device has a case and a wheel assembly disposed at a bottom of the case and connected to the power system to drive the self-propelled device to move.

8. The equipment for eliminating grass seeds in farmland as claimed in claim 2, wherein the self-propelled device has a case and a wheel assembly disposed at a bottom of the case and connected to the power system to drive the self-propelled device to move.

9. The equipment for eliminating grass seeds in farmland as claimed in claim 1, wherein the self-propelled device is controlled by strings, a remote control, a GPS positioning or a laser positioning to walk along the fixed path in the farmland.

10. The equipment for eliminating grass seeds in farmland as claimed in claim 2, wherein the self-propelled device is controlled by strings, a remote control, a GPS positioning or a laser positioning to walk along the fixed path in the farmland.

11. The equipment for eliminating grass seeds in farmland as claimed in claim 3, wherein the self-propelled device is controlled by strings, a remote control, a GPS positioning or a laser positioning to walk along the fixed path in the farmland.

12. The equipment for eliminating grass seeds in farmland as claimed in claim 1, wherein the self-propelled device is provided with plural positioning poles for connecting and fixing the rack to the self-propelled device.

13. The equipment for eliminating grass seeds in farmland as claimed in claim 2, wherein the self-propelled device is provided with plural positioning poles for connecting and fixing the rack to the self-propelled device.

14. The equipment for eliminating grass seeds in farmland as claimed in claim 3, wherein the self-propelled device is provided with plural positioning poles for connecting and fixing the rack to the self-propelled device.

15. The equipment for eliminating grass seeds in farmland as claimed in claim 2, further comprising a sun tracking system having an angle regulation pole passing through the plural trays for regulating a rotation angle of the tray relative to the rack.

16. The equipment for eliminating grass seeds in farmland as claimed in claim 15, wherein the angle regulation pole is controlled manually or automatically by a controller to regulate the rotation angle according to the sunlight duration.

17. The equipment for eliminating grass seeds in farmland as claimed in claim 2, further comprising a temperature sensor connected to the self-propelled device and the power system and having at least one probe disposed at a light path of the plural focusing lenses to detect a temperature of the plural incident rays of sunlight, and wherein the temperature sensor turns on the power system when the temperature of the plural incident rays of sunlight detected by the at least one probe reaches a preset temperature.

18. The equipment for eliminating grass seeds in farmland as claimed in claim 2, wherein the self-propelled device is provided with a scraper at a back side thereof for scratching soils of the farmland to expose the grass seeds buried in the soils.
